(19) United States
(12) Patent Application Publication
(10) Pub. No.: US 2025/0190991 A1
(43) Pub. Date: Jun. 12, 2025

(54) TRANSACTION RISK RULES ENGINE

(71) Applicant: Stripe, Inc., South San Francisco, CA (US)

(72) Inventors: Feng Cao, Lynnwood, WA (US); Elaine Cheng, Mercer Island, WA (US); Samuel Zhu, Los Altos, CA (US); Mu Lin, Palo Alto, CA (US)

(21) Appl. No.: 18/533,064

(22) Filed: Dec. 7, 2023

(51) Int. Cl. G06Q 20/40

(52) U.S. Cl. CPC G06Q 20/4016; G06Q 20/405

(57) ABSTRACT

A service for providing extensible fraud detection may manage the application of a ruleset that evaluates whether or not a transaction is fraudulent. The service groups the features in a ruleset or across multiple rulesets, and dispatches a thread for each group to obtain the feature values for that group. The service evaluates the ruleset with the obtained feature values to determine whether or not a given transaction is fraudulent in view of the ruleset.

### BACKGROUND

Service provider systems provide various services to user systems over computing networks. The services provided can include commercial transaction processing services, media access services, customer relationship management services, data management services, medical services, etc., as well as a combination of such services.

During operations performed by the service provider system during performance of a transaction, the services of the service provider system may generate and store, or seek to access stored, data associated with the service, the transaction, or other data. The data may include data associated with transaction bookkeeping purposes, record keeping purposes, regulatory requirements, end user data, service system data, third party system data, as well as other data that may be generated or accessed during the overall processing of the transaction. The service provider systems may perform millions, billions, or more transactions per hour, day, week, etc., resulting in an enormous scale of data generation and access operations of the services of the service provider system.

To perform transactions, many technical challenges arise. For example, bad actors may seek to exploit such a platform to conduct a fraudulent transaction for their own gain. For example, by using fraudulently obtained payment information that does not belong to a party of the transaction. A service provider system may include safeguards or checks to prevent or help reduce the likelihood of fraudulent transactions.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 illustrates an example of a service provider system, according to an embodiment.

FIG. 2 illustrates an example of how a fraud detection service may perform grouping of features of a ruleset, according to an embodiment.

FIG. 3 shows a flow diagram of a process 300 for providing a service for extensible fraud detection, according to an embodiment.

FIG. 4 shows a flow diagram of a process for providing a service for extensible fraud detection, according to an embodiment.

FIG. 5 shows an example of a service provider system for providing extensible latency-reduced fraud detection, according to an embodiment.

FIG. 6 is one embodiment of a computer system that may be used to support the systems and operations described, according to an embodiment.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “grouping”, “sending”, “dispatching”, “processing”, “authorizing”, “resuming”, “determining”, “resolving”, “providing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

As described, bad actors may wish to conduct a fraudulent activity with a merchant through a digital marketplace (e.g., a merchant system). An intermediary service provider system may help vet transactions that occur at the marketplace, and authorize transactions after being deemed to be non-fraudulent. Current service provider systems may be deficient in capabilities to block card testing (where bad actors ‘test’ a number of fraudulently acquired cards to see which works) or other fraudulent transaction activity using authored internal transaction risk rules, applied across merchants, in the charge path of a transaction. Having this capability allows risk strategists to author rules (e.g., a ruleset) to identify and block emerging card testing attack patterns. Various issues may arise, however. For example, a strategist may author a rule that flags too many transactions as fraudulent, including an unacceptable amount of non-fraudulent transactions. Further, given the various features (e.g., fields) that may be present in a single ruleset, implementation of a single ruleset (much fewer multiple rulesets for a single transaction) may drastically increase latency in processing a transaction. Further, given that bad actors tend to change patterns constantly, the ability to react within minutes to a new fraud pattern is needed.

In embodiments described, a system may generate new rules based on user input that may be implemented immediately for future transactions. During rule creation, the rule may be vetted to determine how many transactions it potentially blocks, or how long it takes to apply the rule to a transaction, or both. This may reduce inadvertently activating a rule that blocks too many transactions or takes too long to apply. Further, when applied, the rule features may be grouped and retrieved in a manner that reduces the latency time there to the longest retrieval time for a given group, rather than the combined time to retrieve each feature individually.

In an aspect, a method, performed by a service for providing extensible fraud detection, comprises receiving a first request to implement a ruleset for evaluating fraud associated with a transaction, wherein the ruleset is associated with a plurality of features; grouping the plurality of features into a plurality of groups based on a respective data source of each of the plurality of features, wherein each of the plurality of groups is associated with a common data source that is different from the respective data source of another one of the plurality of groups; dispatching a processing thread for each one of the plurality of groups to obtain respective feature values of the plurality of features from the respective data source; determining a fraud indication associated with the first request based on applying the feature values to the ruleset; and providing the fraud indication associated with the first request.

The method may further comprise in response to one of the features satisfying a condition associated with a likelihood of reuse, storing in cache memory, a feature value associated with the one of the features; and obtaining the feature value in the cache memory for a second request to implement a second ruleset. Manners in which the features are cached are further described in other sections.

In an embodiment, the fraud indication may be provided to a second service (e.g., a transaction service) for the service to determine whether or not to block the transaction.

In an embodiment, the plurality of features are obtained from data sources comprising at least one of: a machine learning model data source, a data object, or a database. The data sources may be internal to the service or remote.

In an embodiment, the fraud indication indicates a positive indication of fraud in response to the plurality of features satisfying one or more conditions of the ruleset. For example, the method may plug the obtained feature values to the expression of the ruleset, to obtain the result (e.g., fraud or not fraud).

In an embodiment, the method further comprises in response to receiving a new ruleset, applying the new ruleset to historical transactions; and presenting a result of the fraud indications associated with the new ruleset as applied to the historical transactions.

In an embodiment, the method further comprises receiving a second request to implement a second ruleset, wherein grouping the plurality of features into the plurality of groups includes grouping the plurality of features of the first request with a second plurality of features of the second request into one or more common groups in response to a shared data source.

In an embodiment, the first request is received through an application programming interface (API) of the service. Each time a ruleset is added, an API endpoint may be added to the service without new code (e.g., without recompiling and deploying the entire service).

In an embodiment, in response to a number of fraud indications associated with the ruleset exceeding a threshold, the method overrides the fraud indication associated with the first request indicating the transaction as not fraudulent. For example, if a given ruleset indicates fraud for ‘x’ number of past transactions, or at a rate ‘y’, the fraud number or rate may exceed a respective threshold. In response, to mitigate against unexpected behavior or an overly aggressive ruleset, the method may override the fraud indication and provide the fraud indication as not fraud.

Aspects described with respect to a method may be performed in terms of a method may be stored as instructions in non-transitory computer readable storage media. Additionally, or alternatively, aspects described may be performed by a computing node. Aspects described may be performed as a service (e.g., by a server connected to a computer network).

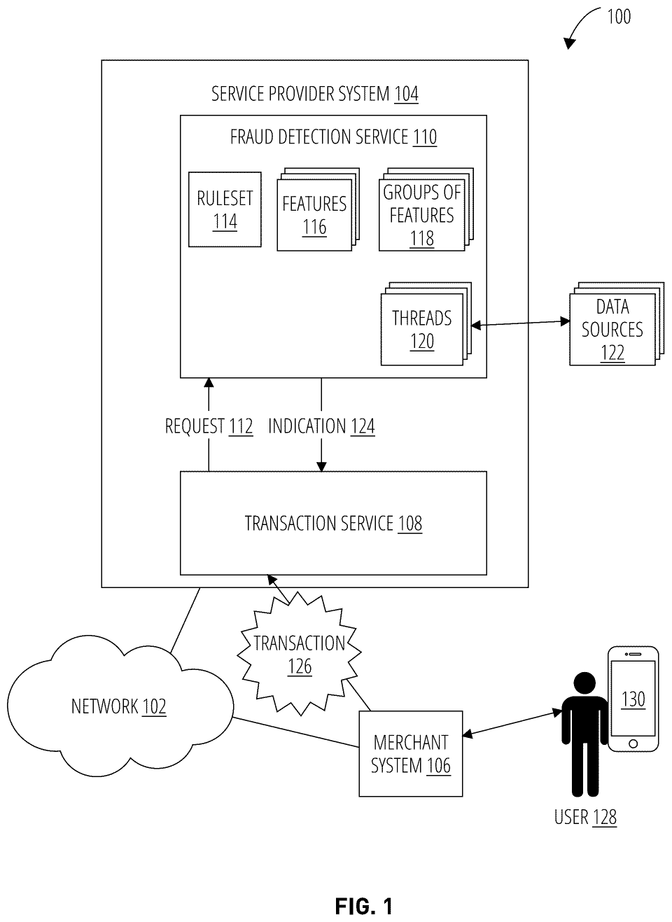

FIG. 1 illustrates an example of a service provider system, in accordance with an embodiment. Service provider system 104 may include one or more server computer systems for whether a transaction 126 (e.g., transaction 126) is associated with fraud. Service provider system 104 may be in communication with a computer network 102 through a computer communication protocol (e.g., TCP/IP, etc.). Generally, service provider system 104 may perform operations that authorize a transaction (e.g., transaction 126) to be completed, and triggers an exchange (e.g., transfer money from an account of an end user 128 to an account associated with merchant system 106. End user 128 may, in some cases, be referred to as a customer or potential customer of merchant system 106. An end user 128 may engage with merchant system 106 (e.g., a merchant website, a merchant application, a digital marketplace, a point of sales at a physical retail location, or other merchant platform) to conduct a transaction. In an example, the end user 128 may operate a network connected device 130 to engage with the merchant system 106, although not necessarily. The device 130 may be connected to the merchant platform through computer network 102 to initiate a transaction 126 (e.g., to buy or sell a product, to transfer money, etc.). The end user 128 may, in some cases, be a fraudulent actor that is testing fraudulently obtained payment information or trying to complete a fraudulent transaction.

Service provider system 104 may comprise a plurality of services such as fraud detection service 110 and transaction service 108. Transaction service 108 may receive a transaction 126 from a merchant system 106 to vet the transaction 126. Service provider system 104 may be configured to perform operations to provide extensible fraud detection. The fraud detection service 110 may receive a request 112 from transaction service 108 to implement a ruleset 114 for evaluating fraud associated with transaction 126. The ruleset 112 may be associated with a plurality of features 116 for resolving the ruleset 114. A ruleset may include one or more rules, each of which may specify one or more features 116, one or more conditions (e.g., logical operations such as if, then, else, or, and, etc.), a threshold, etc., to evaluate whether or not transaction 126 is fraudulent. Different rulesets may be applied to different situations (e.g., based on merchant, transaction metadata, time of day, etc.). A feature 116 may include a transaction detail of interest (e.g., payment information, location of user 128, the type of merchant system 106 that the transaction 126 is being performed over, the time of day, the number of previous transactions by user 128 within a duration of time, a billing address, a shipping address, a time of day, metadata related to the transaction, etc.). Each feature may correspond to a feature value, which is the value for a respective feature as it pertains to a given transaction. For example, if ‘feature’ is ‘mailing address’, the corresponding feature value for a transaction may be ‘1234 Main Street’. Depending the transaction details (e.g., parties to the transaction, payment information used, etc.), the feature value for the same feature may change from one transaction to another. In some cases, obtaining a feature value for feature 116 may include obtaining data from another service. For example, the feature may refer to an output of a machine learning model that is given transaction details as input. Fraud detection service 110 may obtain the feature value (e.g., fraud or not fraud) from the machine learning model. How a ruleset 114 is authored, vetted, and implemented is described in other sections. Implementing a single ruleset 114, much less multiple rulesets for a given transaction, may introduce additional latency to the transaction process. To service a request to resolve a ruleset, the fraud detection service 100 is tasked to obtain each feature value associated with the ruleset, apply the those features values to the ruleset (e.g., plugging those feature values into the ruleset), and performing the one or more operations (e.g., addition, subtraction, if, and, then, or, greater than, less than, etc.) expressed in the ruleset with the obtained feature values to determine whether or not a transaction is fraudulent. Given the many transaction that may take place, and the many requests to implement one or more rulesets for each transaction, it is desirable to resolve a ruleset 114 in a time and computer resource efficient manner.

Fraud detection service 110 may group the plurality of features 116 into a plurality of groups of features 118 based on data source (where the value of that feature is stored). Each of the plurality of groups may be associated with a different respective data source (e.g., one of data sources 122) to obtain one or more of the feature values for the respective one of the plurality of features in the respective group. By forming groups of features with a common data source, a thread may be deployed for each group, thereby utilizing a single thread to obtain multiple feature values from the same data source, as described further below

For example, assuming features 116 includes features A-E (not shown), feature A, feature B, and feature C may be grouped into a common group if they share a common data source, such as if stored in local memory in a common data object (e.g., ‘payment data object’ that stores ‘shipping address’ and ‘billing address’ of the current transaction 126) or in cache memory. Similarly, feature D and feature E may be grouped in a second group of groups 118 if they share a common data source of being obtained at remote server X. The data sources 122 may vary from one feature to another.

Service provider system 104 may store a mapping between each feature and the corresponding data source, and this mapping may be referenced dynamically when implementing a ruleset. This mapping may be initialized by a ruleset author (e.g., ruleset author may define a network address, memory address, or location for each feature, or obtained through other means such as a lookup table. Data sources 122 may include a machine learning model data source, an internal data object, a database, cache memory, or other data source, which varies based on the feature. When a request is received to apply a ruleset, service provider system 104 may refer to the mapping to determine the data source for a given feature, to obtain the feature value for that feature. For example, the mapping may include an address (e.g., a server address that provides a machine learning service) mapped to feature (‘ML_model_output_value’). Service provider system 104 may use that address to communicate the transaction details associated with the request and obtain the feature value (e.g., fraud or not fraud) from the server address. The mapping may be stored within the expression of the ruleset, or separately, or a combination thereof.

Fraud detection service 110 may dispatch a processing thread (e.g., one of threads 120) for each one of the plurality of groups 118, to obtain the respective feature value for each of the plurality of features 116 that are associated with a respective one of the plurality of groups 118 from the respective data source 122. For example, group 1 may include feature A, B, and C that are obtainable from a local data object (which is the data source for this group). A first thread is deployed where that thread's sole task is to gather the feature values associated with feature A, feature B, and feature C from the local data object. This may include determining reading the values from the data source (e.g., the local data object) and writing them into memory (or using points) to refer to those feature values in order to solve the ruleset. This may be repeated for the different groups which each have a different data source. The operations to retrieve the feature values may vary depending on the data source (e.g., obtaining feature values from a remote data source may include invoking an API call). The threads 120 may be dispatched to obtain the features in parallel. These threads may execute concurrently, sharing processor resources and/or memory resources. Each thread may be referred to as an independent unit of execution within the fraud detection service 110. The ruleset 114 may be resolved once all features 116 are obtained. By grouping the features, and dispatching separate threads for each group, fraud detection service may reduce latency in resolving a given ruleset 114. For example, latency to resolve ruleset 114 may be a function of the slowest feature retrieval of a single group, as opposed to the combined retrieval time of all the features of the ruleset. Further, if evaluating multiple rulesets, features can be grouped across different rulesets to further reduce latency, as described further in other sections. The time to vet a transaction may be reduced, thereby reducing the overall time to perform a transaction.

Fraud detection service 110 may provide (e.g., to transaction service 108) a fraud indication 124 associated with the first request 112, based on resolving the ruleset 114 with the plurality of features 116. For example, fraud indication 124 may include a binary fraud indicator that indicates a positive (e.g., fraudulent) or negative (e.g., not fraudulent). In another example, fraud indicator may be a score (e.g., 0-100) that indicates a likelihood of fraud associated with transaction 126.

Transaction service 108 may include one or more operations that, based on the fraud indication 124 determines whether or not to complete transaction 126. For example, in response to the fraud indication 124 being positive or exceeding a threshold, transaction service 108 may deem the transaction 126 to be fraudulent and block transaction 126. In response to the fraud indication 124 being negative (not fraud) or not satisfying the threshold (e.g., fraud score is not above ‘x’), transaction service 108 may authorize transaction 126 through signaling with merchant system 106, thereby triggering completion of the transaction 126.

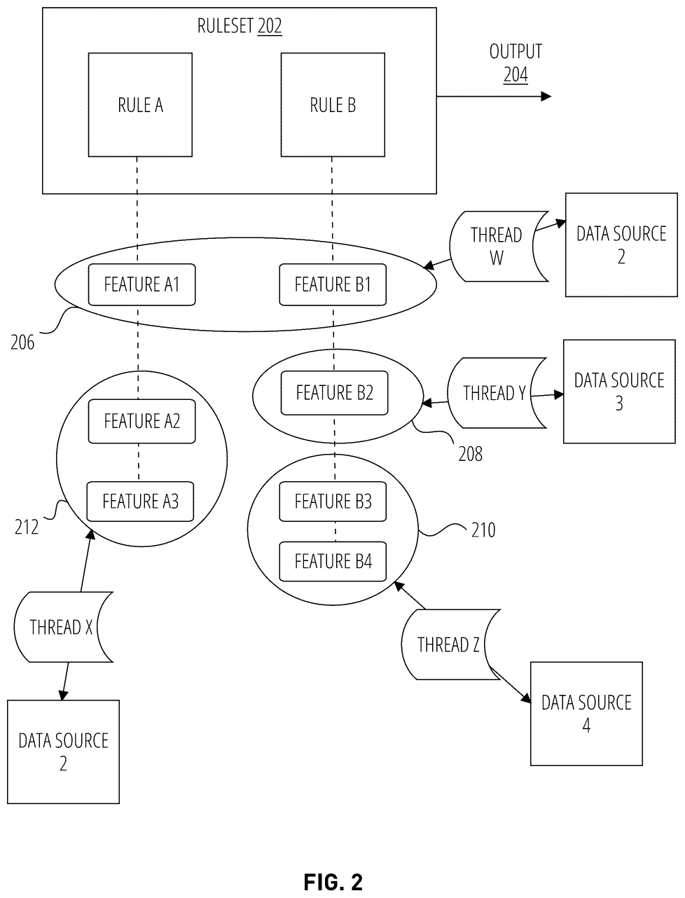

FIG. 2 illustrates an example of how a fraud detection service may perform grouping of features of a ruleset, in accordance with an embodiment. Generally, a ruleset 202 comprises a set of rules that state conditions for when a feature would trigger fraud. For example, ruleset 202 may include rule A and rule B. Rule A may state a condition like if feature A1 (fraud value from server 1) or both feature A2 and feature A3 indicate fraud (e.g., if the distance between billing address A2 and mailing address A3 exceed a threshold) then rule A indicates fraud. Similarly, rule B may state that if any one of feature B1 (e.g., past transactions in last 3 days exceed threshold), B2 (past transactions within time window exceeds threshold), B3 (past transactions associated with flagged transactions), or B4 (specified metadata of transaction is present) indicate fraud, then rule B indicates fraud. Ruleset 202 may further state that if either rule A or rule B are evaluated as fraud, then output 204 will indicate fraud.

Processing logic may group features from rule A and rule B as a whole based on data source. For example, processing logic may group feature A1 and feature B1 together into group 206 because they are to be obtained from the same data source 1. Similarly, features A2 and A3 may be grouped together into group 212 because they share a common data source 2. Assuming feature B2 does not have a data source in common with other features, it may be grouped by itself in group 208. Feature B3 and B4 may be grouped together in group 210 for having a common data source 4. Although examples of data sources and groupings are provided in FIG. 2 and throughout the disclosure, it should be understood that these examples are for illustration and that data sources may vary from one ruleset to another.

Processing logic may deploy a respective thread for each of the groups, and deploy them (e.g., in parallel) to obtain the features. For example, feature A1 and feature B1 may each refer to obtaining a value from a machine learning model as to whether or not a transaction is fraudulent. In such a case, thread W may be deployed to interact with an API of the data source (e.g., machine learning model service) to retrieve the respective feature values corresponding to the features. The feature values are then evaluated both for rule A and rule B. Similarly, feature A2 and feature A3 may refer to values extracted out of metadata from the transaction (e.g., merchant identifier, end user identifier, shipping address, mailing address, payment information, transaction amount, etc.) and stored locally (within the platform) in a known data object (e.g., ‘transaction data object’). Thread X may be deployed to retrieve the values corresponding to the feature values for features A2 and A3 from the known data object, and so on. The threads may be deployed to execute concurrently.

By grouping the features based on data source, and dispatching threads for each grouping, processing logic may reduce latency to evaluate ruleset 202, which enables faster fraud detection processing. Further, processing logic can group features from different rulesets according to data source. For example, assuming that rule A is defined by ruleset 202, and rule B is defined by a different ruleset (not shown), processing logic may still group features from rule A and rule B together if they share a common data source. Processing logic may group the features and deploy threads as shown to evaluate multiple rulesets in parallel.

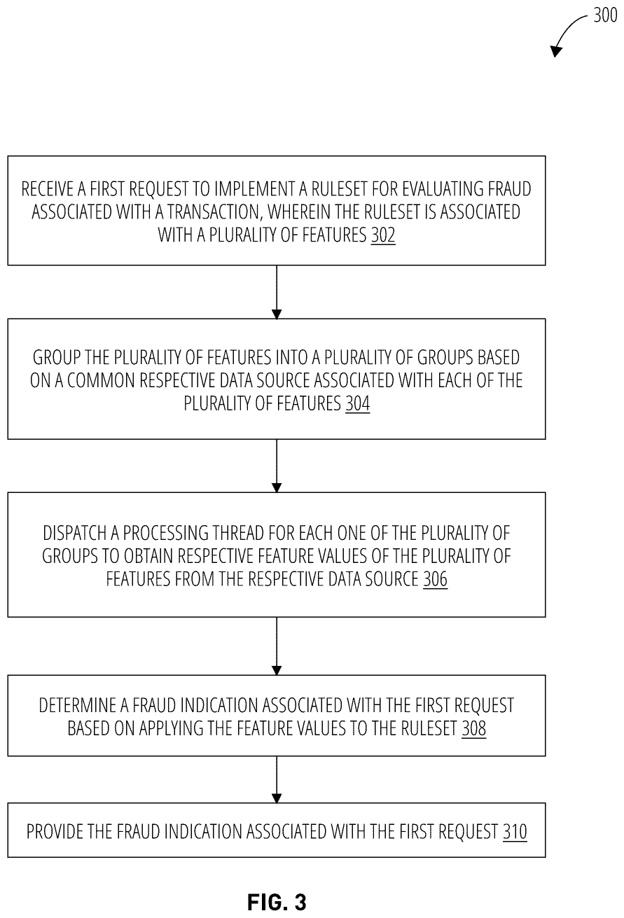

FIG. 3 shows a flow diagram of a process 300 for providing a service for extensible fraud detection, according to an embodiment. The process 300 may be performed by processing logic that may comprise hardware (circuitry, dedicated logic, etc.), software (such as is run on a general-purpose computer system or a dedicated machine), firmware, or a combination. In one embodiment, the process may be performed by a service provider system 104.

At block 302, processing logic may receive a first request to implement a ruleset for evaluating fraud associated with a transaction, wherein the ruleset is associated with a plurality of features. At block 304, processing logic may group the plurality of features into a plurality of groups based on a common respective data source associated with each of the plurality of features. Each group may be associated with a different data source.

At block 306, processing logic may dispatch a processing thread for each one of the plurality of groups to obtain respective feature values of the plurality of features from the respective data source. The plurality of feature values may be obtained from data sources comprising at least one of: a machine learning model data source, an internal data object, or a database. A machine learning model data source may include a remote server (e.g., software as a service (SAAS)) that takes transaction data as input and generates an output (e.g., an indication of fraud) which may be received as the feature value. An internal data object may include a data object that is stored in memory that is directly accessible to processing logic. The data object may include one or more of the feature values that processing logic has previously collected and stored. The database may be a remote or local database which may include stored features. Each feature value may represent a variable (e.g., fraud likelihood, amount of transaction, time of transaction, etc.) and obtaining the feature value may include obtaining the value (e.g., through reading memory, performing an API call, etc.) associated with the feature.

For example, a ruleset may be defined as: ‘IF fraud_score_from_ML_model>threshold X, AND distance between shipping address and mailing address>threshold Y, THEN fraud=true. In such a case, processing logic may dispatch a first thread to obtain the fraud_score_from_ML_model and a second thread to simultaneously obtain ‘shipping address’ and ‘mailing address’ (e.g., from a common local data object).

At block 308, processing logic may determine a fraud indication associated with the first request based on applying the feature values to the ruleset. Processing logic may evaluate the fraud indication and provide a positive indication of fraud in response to the plurality of feature values satisfying one or more conditions of the ruleset. For example, processing logic may evaluate the ruleset: [ML_model>threshold X, AND distance between shipping address and mailing address>threshold Y, THEN fraud=true] with the obtained feature values (from block 306). In this example, if the threshold X and threshold Y are both satisfied, then the fraud indication may be true. At block 310, processing logic may provide the fraud indication associated with the first request (e.g., to a second service that the first request was received from). Receiving a request and providing indication may be performed through local messaging between services and/or using a network protocol over a computer network.

In an embodiment, processing logic may store one or more of the plurality of feature values in cache memory, obtained for the first request. Processing logic may obtain the one or more of the plurality of feature values in the cache memory for a second request to implement a second ruleset. The second ruleset may be evaluated for the same transaction or for a different transaction. This may reduce evaluation latency by storing some feature values in cache to be retrieved at a later time. Processing logic may store feature values for features deemed to be popular. For example, processing logic may track the number of times a feature is requested, and after a threshold number of retrievals for that feature are requested, store this feature value in cache for future transactions or rulesets.

Processing logic may provide the fraud indication to a transaction service, and in response to the fraud indication including a positive indication of fraud, the transaction service blocks the transaction. In response to providing a negative fraud indication, the transaction service may authorize the transaction (e.g., through signaling with the merchant system) to complete the transaction.

Processing logic may receive rulesets from users (e.g., administrators). Processing logic may provide a user interface (e.g., a graphical user interface or command line prompt) that allows users to define and enter a new ruleset. The ruleset may be defined in an agreed upon convention (e.g., with syntax defining each feature, logical operators, etc.). The user may define when each ruleset is to be applied (e.g., for all merchants, for merchant X, for all merchants except merchant Y, etc.).

In an embodiment, in response to receiving a new ruleset, processing logic may apply the new ruleset to historical transactions and present a result of fraud indications associated with the new ruleset as applied to the historical transactions. This may help vet new rulesets. For example, if a user enters a new ruleset, processing logic may apply this ruleset to 1000 past transactions (and their respective transaction data) to simulate and evaluate how those transactions fair against the ruleset. Processing logic may present the results to the user (e.g., through a display) such as how many of the transactions were indicated as fraudulent (e.g., 45 of the 1000 past transactions) based on the ruleset. Thus, processing logic may test a new ruleset prior to implementation so that the author of the ruleset can evaluate if the ruleset is overly aggressive (e.g., blocks more than a threshold number of transactions). Processing logic may also group the needed features of the ruleset and simulate and/or calculate the time taken to obtain each of the feature values of the ruleset with dispatched threads per-group and present this to the user. Processing logic may provide an indication or warning (e.g., a visual indication or warning) if the time is over a threshold, to let the user adjust the rule to reduce this latency. In an embodiment, processing logic may automatically block the addition of a new rule if added the latency is above a threshold, and/or if the new rules blocks a threshold rate or number of the past transactions. Generally, in the present disclosure, an automatic operation may refer to an operation that is performed without human guidance or input.

In an embodiment, processing logic may group features of different rulesets together for retrieval. For example, processing logic may receive a second request to implement a second ruleset. Processing logic may group the plurality of features of the first request with a second plurality of features of the second request into one or more common groups in response to a shared data source (e.g., as described relative to FIG. 2).

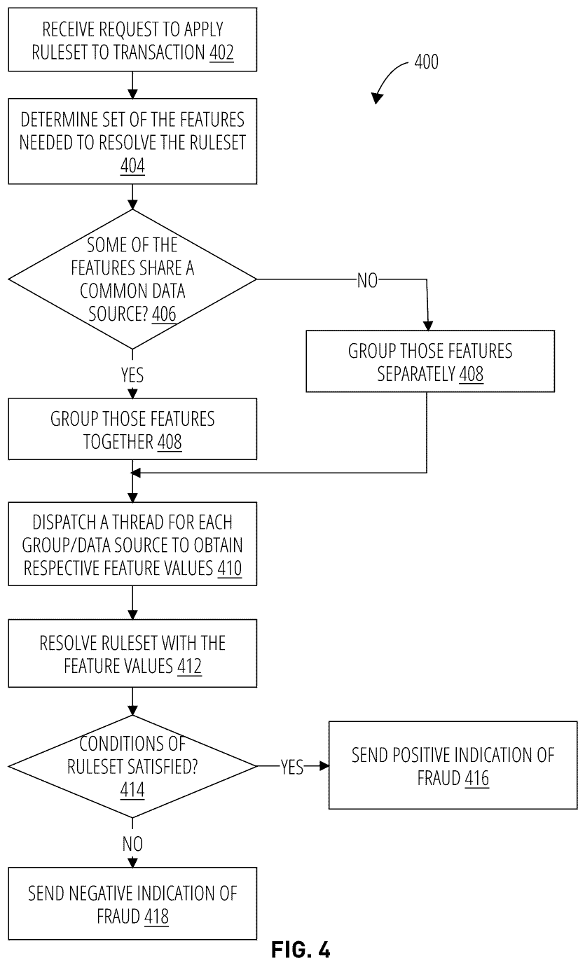

FIG. 4 shows a flow diagram of a process for providing a service for extensible fraud detection, according to an embodiment. The process 400 may be performed by processing logic that may comprise hardware (circuitry, dedicated logic, etc.), software (such as is run on a general-purpose computer system or a dedicated machine), firmware, or a combination. In one embodiment, the process may be performed by a fraud detection service 110 or fraud detection service 504.

At block 402, processing logic may receive a request to apply a ruleset to a transaction. This may be an in-progress transaction between a user and a merchant.

At block 404, processing logic may determine a set of features needed to resolve the ruleset. For example, processing logic may examine the ruleset to extract a list of features that are called out in the ruleset.

At block 406, processing logic may determine which of the features share a common data source. For the features that share a common data source, processing logic proceeds to block 408 and groups those features together. For the features that do not share a common data source, processing logic proceeds to block 408 and groups those features separately. For both cases, processing logic proceeds to block 410.

At block 410, processing logic dispatches a thread for each group/data source combination, to obtain the respective feature values of the features. This may include deploying multiple threads in parallel (concurrent execution) to obtain the feature values from the respective data sources. Further, a single one of the threads may obtain the feature values for multiple rules and/or rulesets when features across rules or rulesets are grouped together.

At block 412, processing logic may resolve a ruleset with the feature values. At block 414, processing logic may plug the obtained feature values for each feature into the ruleset expression, to determine whether or not the conditions of the ruleset are satisfied. If satisfied, processing logic may proceed to block 416 and send a positive indication of fraud for the applied ruleset. If not satisfied, processing logic may proceed to block 418 and send a negative indication of fraud, for the applied ruleset. The indication may be sent to a transaction service that may then authorize the transaction, depending on if the indication of fraud is positive (e.g., fraud) or negative (e.g., not fraud).

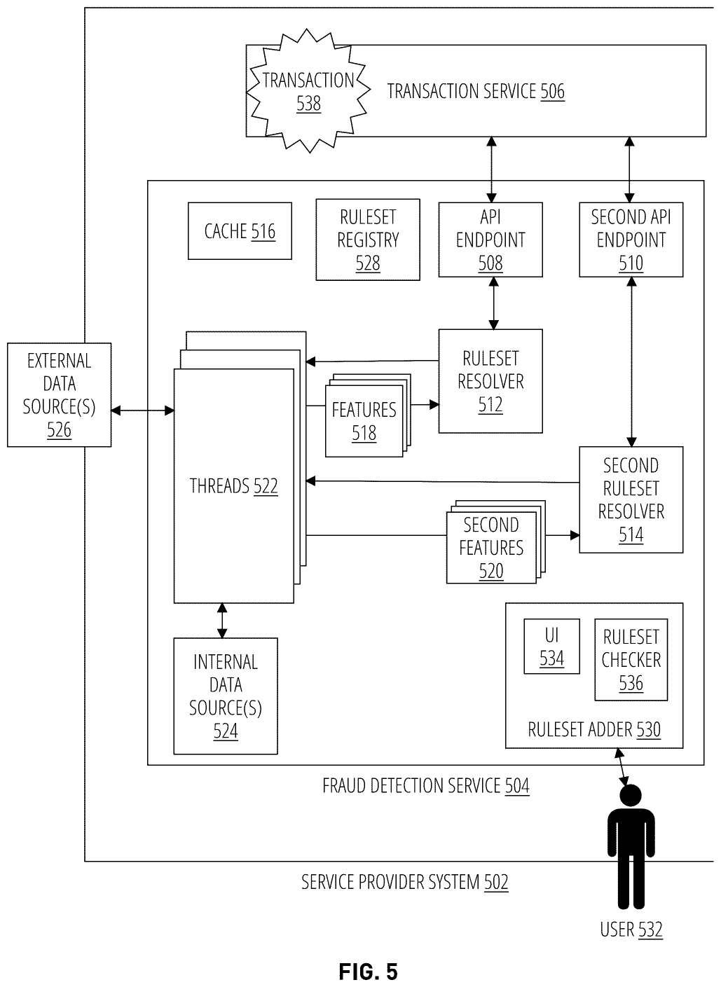

FIG. 5 shows an example of a service provider system for providing extensible latency-reduced fraud detection, in accordance with an embodiment. Service provider system 502 share embodiments described with respect to service provider system 104 even if not expressly stated.

Service provider system 502 may include a transaction service 506 that may correspond to transaction service 108. Service provider system 502 may include a fraud detection service 504 that detects whether or not a transaction 538 is associated with fraud.

Fraud detection service 504 may comprise a ruleset adder 530 for a user 532 to add a new ruleset. A user may input (e.g., through user interface 534) an expression that defines a new ruleset and the features of the new ruleset. The expression may include logical operators (e.g., IF, THEN, ELSE, AND, OR, etc.) and features related with a transaction as described, that define whether or not a transaction is to be deemed fraudulent.

Ruleset checker 536 may apply this ruleset to past transactions to determine the rate at which this new ruleset detects fraud in the past transactions. UI 534 may present the results to user 532 so that the user 532 may determine whether or not the new ruleset is too aggressive (flags too many transactions as fraudulent) or not aggressive enough (does not flag enough transactions as fraudulent). In an embodiment, if the rate is not within a range (e.g., if it blocks more or less than threshold number of transactions), UI 534 may present a warning notification to the user 532. If the user 532 confirms adding a new ruleset, ruleset adder 539 may register the new ruleset in a ruleset registry 528 which may include all rulesets handled by fraud detection service 504. Further, ruleset checker 536 may simulate time to execute a new ruleset, including grouping the features of the new ruleset, dispatching threads to obtain the grouped features (using a single thread per group as described), and resolving the ruleset with the obtained features. This duration of time may be presented through UI 534. As described, in an embodiment, UI 534 may display a warning indication if the duration of time exceeds a threshold. Further, ruleset checker 536 may block new rulesets or deactivate existing registered rulesets if their latency exceeds a threshold or if the rate or number of blocked transactions by that ruleset exceeds a threshold.

Fraud detection service 504 may comprise an API endpoint for each ruleset that it is registered in ruleset registry 528. Each time a user 532 adds a ruleset to the ruleset registry 528, the fraud detection service 504 may generate a respective API endpoint to handle requests specifically for that ruleset. With such an architecture, fraud detection service 504 may improve extensibility because new code need not be written or deployed for each new ruleset.

For example, user 532 may add a first ruleset with one or more rules that each reference one or more features 518. Fraud detection service 504 may automatically add API endpoint 508 that handles requests for resolving this first ruleset. Similarly, user 532 may add a second ruleset with one or more rules that each reference one or more second features 520. In response, fraud detection service 504 may automatically add second API endpoint 510 to handle requests for resolving this second ruleset.

In an embodiment, fraud detection service 504 may store one or more features in cache 516 during processing a request to implement a first ruleset, which may be obtained from the cache 516 to process a second ruleset (e.g., within the same or different transaction). Cache 516 may be a data source that features are grouped upon. As with other data sources, fraud detection service 504 may keep track of which features may be obtained in cache 516 with known management techniques (e.g., cache mapping). Fraud detection service 504 may cache every obtained feature (e.g., in a first-in-first-out manner). Alternatively, fraud detection service 504 may implement one or more cache algorithms to determine when to cache a feature. Fraud detection service 504 may store a feature value in cache in response to a determination that the feature value satisfies a condition (e.g., a threshold or flag) associated with a likelihood of re-usage. For example, fraud detection service may set a flag for some features (e.g., popular features) to be cached while unmarked features will not be cached. In an example, fraud detection service 504 may set the flag for a feature to be cached based on user input (e.g., a user may specify, when authoring a ruleset, which features are to be cached, or if all features for the ruleset are to be cached). The feature values for those features with a flag set will be cached, and those without the flag set may not be cached. In an example, fraud detection service 504 may scan the rulesets in ruleset registry 528 and rank the features based on how many times each feature is called within the registered rulesets. Those features called out the most may be ranked higher than those features with less mentions in the registered rulesets. Fraud detection service 504 may cache those feature values associated with features ranked higher than a threshold (e.g., the top ‘x’ ranked features are to be cached, and the remaining will not). Additionally, or alternatively, fraud detection service 504 may determine or update rank of features based on how often that feature is called upon after deployment. For example, during processing of many transactions, the ranking may be performed continuously to dynamically adapt the ranking, to determine which of the feature values are to be cached and which are not, based on counting and ranking which features are called out the most. Other caching schemes may be implemented. Caching schemes may also be combined. The system may automatically implement caching features described. Based on the various caching features described, the system may further reduce latency that may otherwise be introduced by obtaining features.

When an in-progress transaction 538 is received, transaction service 108 may send a request to resolve one or more rulesets for the transaction, to determine if the transaction is to be deemed as fraudulent. For example, the transaction service 506 may send a first request to fraud detection service 504 to evaluate a first ruleset through an application programming interface (API) 508, and a second request to resolve a second ruleset through second API endpoint 510. Fraud detection service 504 may examine each of the features 518, 520 to determine which of internal data sources 524 or an external data source 526 are common to the features 518. This may be done in combination (e.g., grouping features from the first ruleset and second ruleset together when there is a shared data source), or separately (e.g., keeping features from the first ruleset and second ruleset separate when grouping).

Each one of threads 522 is deployed to retrieve the feature values of a single grouping of features. The retrieved feature values are returned to ruleset resolver 512 and ruleset resolver 514 respectively. At ruleset resolver 512 and 514, the rulesets are resolved with the retrieved feature values. Resolving the ruleset includes determining if the conditions of a ruleset are satisfied. If so, ruleset resolver 512, 514, may return a positive indication of fraud through their respective API endpoints 508, 510, to transaction service 506. Transaction service 506 may complete or block a transaction accordingly. In the case of multiple rulesets, transaction service 506 may include additional logic that may determine whether or not to block the transaction in view of multiple results (e.g., if every ruleset indicates fraud, or if a single ruleset indicates fraud).

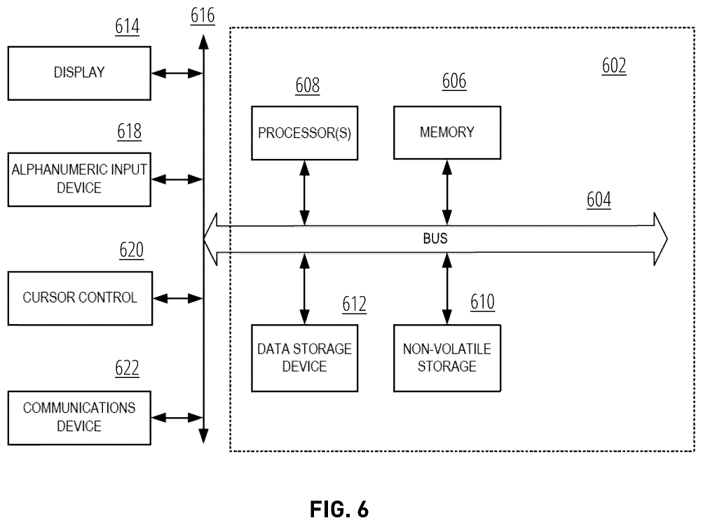

FIG. 6 is one embodiment of a computer system that may be used to support the systems and operations described, according to an embodiment. For example, the computer system illustrated in FIG. 6 may be used by a commerce platform system, a merchant development system, merchant user system, etc. It will be apparent to those of ordinary skill in the art, however that other alternative systems of various system architectures may also be used.

The computer system 602 illustrated in FIG. 6 includes a bus or other internal communication means 604 for communicating information, and one or more processors 608 coupled to the bus 604 for processing information. The system further comprises a random-access memory (RAM) or other volatile storage device 606 (referred to as memory), coupled to bus 604 for storing information and instructions to be executed by processor 608. Main memory 606 also may be used for storing temporary variables or other intermediate information during execution of instructions by processor 608. The system also comprises a read only memory (ROM), non-volatile storage, and/or static storage device 610 coupled to bus 604 for storing static information and instructions for processor 608, and a data storage device 612 such as a magnetic disk or optical disk and its corresponding disk drive. Data storage device 612 is coupled to bus 604 for storing information and instructions.

The system may further be coupled to a display device 614, such as a light emitting diode (LED) display, or a liquid crystal display (LCD) coupled to bus 604 through bus 616 for displaying information to a computer user. An alphanumeric input device 618, including alphanumeric and other keys, may also be coupled to bus 604 through bus 616 for communicating information and command selections to processor 608. An additional user input device is cursor control device 620, such as a touchpad, mouse, a trackball, stylus, or cursor direction keys coupled to bus 604 through bus 616 for communicating direction information and command selections to processor 608, and for controlling cursor movement on display device 614.

Another device, which may optionally be coupled to computer system 602, is a communication device 622 for accessing other nodes of a distributed system via a network. The communication device 622 may include any of a number of commercially available networking peripheral devices such as those used for coupling to an Ethernet, token ring, Internet, or wide area network. The communication device 622 may further be a null-modem connection, or any other mechanism that provides connectivity between the computer system 602 and the outside world. Note that any or all of the components of this system illustrated in FIG. 6 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 606, mass storage device 612, or other storage medium locally or remotely accessible to processor 608.

It will be apparent to those of ordinary skill in the art that the system, method, and process described herein can be implemented as software stored in main memory 606 or read only memory and executed by processor 608. This control logic or software may also be resident on an article of manufacture comprising a computer readable medium having computer readable program code embodied therein and being readable by the mass storage device 612 and for causing the processor 608 to operate in accordance with the methods and teachings herein.

The embodiments discussed herein may also be embodied in a handheld or portable device containing a subset of the computer hardware components described above. For example, the handheld device may be configured to contain only the bus 604, the processor 608, and memory 606 and/or 612. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 608, a data storage device 612, a bus 604, and memory 606, and only rudimentary communications mechanisms, such as a small touchscreen that permits the user to communicate in a basic manner with the device. In general, the more special purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A method, performed by a service for providing extensible fraud detection, comprising:
receiving a first request to implement a ruleset for evaluating fraud associated with a transaction, wherein the ruleset is associated with a plurality of features;
grouping the plurality of features into a plurality of groups based on a common respective data source associated with each of the plurality of features;
dispatching a processing thread for each one of the plurality of groups to obtain respective feature values of the plurality of features from the respective data source;
determining a fraud indication associated with the first request based on applying the feature values to the ruleset; and
providing the fraud indication associated with the first request.

2. The method of claim 1, further comprising:
in response to one of the features satisfying a condition associated with a likelihood of reuse, storing in cache memory, a feature value associated with the one of the features; and
obtaining the feature value in the cache memory for a second request to implement a second ruleset.

3. The method of claim 1, wherein the fraud indication is provided to a transaction service for the transaction service to determine whether or not to block the transaction.

4. The method of claim 1, wherein the plurality of features are obtained from data sources comprising at least one of: a machine learning model data source, an internal data object, or a database.

5. The method of claim 1, further comprising:
in response to receiving a new ruleset, applying the new ruleset to historical transactions; and
presenting a result of the fraud indications associated with the new ruleset as applied to the historical transactions.

6. The method of claim 1, further comprising:
receiving a second request to implement a second ruleset and grouping the plurality of features of the first request with a second plurality of features of the second request into one or more common groups in response to a shared data source.

7. The method of claim 1, wherein the first request is received through an application programming interface (API) of the service.

8. The method of claim 1, wherein in response to a number of fraud indications associated with the ruleset exceeding a threshold, overriding the fraud indication associated with the first request as not fraud.

9. One or more non-transitory computer readable storage media having instructions stored thereupon which, when executed by a system having at least a processor and a memory therein, cause the system to perform processes to provide extensible fraud detection, comprising:
receiving a first request to implement a ruleset for evaluating fraud associated with a transaction, wherein the ruleset is associated with a plurality of features;
grouping the plurality of features into a plurality of groups based on a common respective data source associated with each of the plurality of features;
dispatching a processing thread for each one of the plurality of groups to obtain respective feature values of the plurality of features from the respective data source;
determining a fraud indication associated with the first request based on applying the feature values to the ruleset; and
providing the fraud indication associated with the first request.

10. The non-transitory computer readable storage media of claim 9, further comprising:
in response to one of the features satisfying a condition associated with a likelihood of reuse, storing in cache memory, a feature value associated with the one of the features; and
obtaining the feature value in the cache memory for a second request to implement a second ruleset.

11. The non-transitory computer readable storage media of claim 9, wherein the fraud indication is provided to a transaction service for the transaction service to determine whether or not to block the transaction.

12. The non-transitory computer readable storage media of claim 9, wherein the plurality of features are obtained from data sources comprising at least one of: a machine learning model data source, an internal data object, or a database.

13. The non-transitory computer readable storage media of claim 9, wherein the processes further comprise:
in response to receiving a new ruleset, applying the new ruleset to historical transactions; and
presenting a result of the fraud indications associated with the new ruleset as applied to the historical transactions.

14. The non-transitory computer readable storage media of claim 9, wherein the processes further comprise:
receiving a second request to implement a second ruleset and grouping the plurality of features of the first request with a second plurality of features of the second request into one or more common groups in response to a shared data source.

15. The non-transitory computer readable storage media of claim 9, wherein the first request is received through an application programming interface (API) of the service.

16. A computer node for providing an extensible fraud detection service, comprising:
a memory having instructions stored thereupon; and
one or more processors coupled with the memory, configured to execute the instructions, causing the one or more processors to perform processes, comprising:
receiving a first request to implement a ruleset for evaluating fraud associated with a transaction, wherein the ruleset is associated with a plurality of features;
grouping the plurality of features into a plurality of groups based on a common respective data source associated with each of the plurality of features;
dispatching a processing thread for each one of the plurality of groups to obtain respective feature values of the plurality of features from the respective data source;
determining a fraud indication associated with the first request based on applying the feature values to the ruleset; and
providing the fraud indication associated with the first request.

17. The computer node of claim 16, wherein the processes further comprise:
in response to one of the features satisfying a condition associated with a likelihood of reuse, storing in cache memory, a feature value associated with the one of the features; and
obtaining the feature value in the cache memory for a second request to implement a second ruleset.

18. The computer node of claim 16, wherein the fraud indication is provided to a transaction service for the transaction service to determine whether or not to block the transaction.

19. The computer node of claim 16, wherein the plurality of features are obtained from data sources comprising at least one of: a machine learning model data source, an internal data object, or a database.

20. The computer node of claim 16, wherein the processes further comprise:
in response to receiving a new ruleset, simulating the new ruleset to determine a latency of the new ruleset; and
presenting the latency of the new ruleset, as applied to the historical transactions.
